(19) United States
(12) Patent Application Publication
(10) Pub. No.: US 2006/0158463 A1
(43) Pub. Date: Jul. 20, 2006

(54) Online digital and analog photographic album design and album ordering system

(76) Inventor: William N. Michlin, Deerfield, IL (US)

Correspondence Address: PERKINS COIE LLP, P.O. BOX 2168, MENLO PARK, CA, 94026, US

(21) Appl. No.: 11/334,058

(22) Filed: Jan. 17, 2006

Related U.S. Application Data
(60) Provisional application No. 60/643,849, filed on Jan. 14, 2005.

(51) Int. Cl. G09G 5/00

(52) U.S. Cl. 345/634

(57) ABSTRACT

A turnkey solution is provided to users who wish to create a customized photo album with personalized features. The turnkey solution is an online system for designing and printing or designing and printing and binding photo albums. According to certain embodiments, such an online system includes providing a web-based workstation application that guides the user through a no-fault workflow procedure for specifying design, print and album production features.

### CROSS REFERENCE TO RELATED APPLICATIONS

This application claims the benefit of U.S. Provisional Patent Application No. 60/643,849 filed Jan. 14, 2005, entitled, “ALBUM DESIGNER NETWORK SYSTEM (SYSTEM AND METHOD FOR DESIGN AND CUSTOMIZATION OF A PHOTO ALBUM),” by William Michlin, and which is hereby incorporated by reference in its entirety.

### TECHNICAL FIELD

The present invention is directed to the field of online services, and more specifically to aspects of online album design, product ordering and image submission.

### BACKGROUND

The process of creating a customized photo album is a multi-faceted task that includes selecting vendors for printing, and bindery. Further, decisions as to type, style, color, materials of albums need to be made. A photographer may also choose to outsource the design of images and/or the production of the album to professional graphic designers, color labs and album binderies. Thus, it can be appreciated that the multi-faceted task of creating a customized photo album is time-consuming and requires considerable effort in managing and coordinating with the different vendors and designers before a customized album is produced. In the case of a professional photographer, for example, the amount of effort increases exponentially when the photographer is faced with creating a multiplicity of customized albums in the course of servicing the photographer's various clients.

Thus, there is a need for a convenient turnkey solution for creating customized albums with personalized features.

### BRIEF DESCRIPTION OF THE DRAWINGS

FIG. 1 is a block diagram that illustrates an overview of workflow through the ADN System, according to certain embodiments.

FIG. 2 is snapshot of an online control panel that can be accessed by members of the ADN System for tracking each phase in the making of a given album, according to certain embodiments.

FIG. 3 shows a sample home page of the ADN System website, according to certain embodiments.

FIG. 4 is shows a web page 400 that a photographer sees when the photographer enters the ADN Workstation application, according to certain embodiments.

FIG. 5 shows the Design Options page 500 of the ADN workstation application, according to certain embodiments.

FIG. 6 shows the Album Type page 600 of the ADN workstation application, according to certain embodiments.

FIG. 7 shows the Album Size page 700 of the ADN workstation application, according to certain embodiments.

FIG. 8 shows the Gilding Color page 800 of the ADN workstation application, according to certain embodiments.

FIG. 9 shows the Album Material page 900 of the ADN workstation application, according to certain embodiments.

FIG. 10 shows the Album Color page 1000 of the ADN workstation application, according to certain embodiments.

FIG. 11 shows the Cover Cameo page 1100 of the ADN workstation application, according to certain embodiments.

FIG. 12 shows the Album Inscription page 1200 of the ADN workstation application, according to certain embodiments.

FIG. 13 shows the Slipcase page 1300 of the ADN workstation application, according to certain embodiments.

FIG. 14 shows the Album Quantity page 1400 of the ADN workstation application, according to certain embodiments.

FIG. 15 shows the Create Replica Album page 1500 of the ADN workstation application, according to certain embodiments.

FIG. 16 shows the Album Size page 1600 of the ADN workstation application for the replica album, according to certain embodiments.

FIG. 17 shows the Album Cover page 1700 of the ADN workstation application for the replica album, according to certain embodiments.

### DETAILED DESCRIPTION

According to certain embodiments, a turnkey solution is provided to users who wish to create a customized photo album with personalized features. According to one aspect, the turnkey solution is an online system for designing, printing, binding and ordering photo albums. According to certain embodiments, such an online system includes providing a web-based workstation. A user can access such an online system through a web browser from any location and using any operating system. The user-interface of such a system guides the user through a no-fault workflow procedure for specifying design features and for making selections as to type, style, material, format, etc., of a given customized photo album. According to another aspect, the user is provided with a choice of various vendors for printing, graphic design and bindery as part of the online workflow process. According to another aspect, such a turnkey solution includes an online tracking and notification system for tracking progress in one or more phases of the album creation process. Such a turnkey system is herein referred to as an Album Design Network (ADN) System

Users of the ADN system are photographers, both amateur and professional, or any person who is seeking a convenient avenue for creating a customized photo album. In a nutshell, the user can use the ADN System to create digitally designed event albums by outsourcing all production work to a network of specialized vendors to produce a finished photographic album after the images from an event have been selected for display in an album.

There are four main components that make up the ADN System. The four components are the color laboratory, graphic designers, album bindery and the customized software. These components are part of the ADN System that utilizes a wide area network connected via the Internet, for example. Each component has a specific role in completing the prints for the album pages and the overall production of the album. The color laboratory performs functions such as color correcting the images, and producing the color prints to be used for the pages in the final album. The graphic designers provide the artistic composition to digitally enhance the images provided by the photographer into a story line of the event at which the images were taken. The album bindery receives digitally enhanced and color-corrected color prints and binds them into pages and creates the finished album, according to the specifications selected by the user. The components of the ADN System are integrated to work seamlessly to produce an artistically crafted custom designed photo album. All participating vendors and members have web access to the ADN System. The final album is shipped by the bindery directly to the user. The photographer (user) can register as a member in the network either through the web site of a participating color lab or that of a participating bindery, according to certain embodiments. The photographer pays for services to the vendor through whose web site the photographer registered. The vendor collects the revenue from the photographer and in turn pays the ADN System members who provided services in the production of the album. Alternatively, the photographer can pay directly to ADN home office, and the ADN home office will pay the relevant vendors who provided services in the production of the album. The software utilized by the photographers includes a routing system between the ADN System services via FTP internet services, for example, and a reporting system that generates e-mails and back-end reporting accounting information. The participating vendors have access to a control panel that can be used to access an accounting system to keep track of receivables and payables. The ADN System provides different vendors within the system a snapshot of the amounts owed between participating vendors, according to certain embodiments. When a vendor pays his bills, he can click on the ‘mailed’ to generate a date of record to show the payee that a payment was sent. This financial information will appear on the control box under a financial status box that indicates “open”, “sent”, or “received”, for example. The ADN System provides other accounting features such as are cumulative totals for receivables and payables for each vendor. The vendor has the ability to insert dates, months, quarters, or years for statistical analysis and taxes, according to certain embodiments.

The online routing system provides a convenient and efficient method of routing the photographer's images between the photographer and the vendors, such as the color lab, graphics designers, bindery and the administrative staff of the ADN system.

Photographers can logon to the ADN website at anytime to track the production phase of their album orders. At key times during the production of any given album, an automated e-mail alert message is generated to notify the photographer that his input is required. For example, the email message may alert the photographer to review the preliminary design, or to give input for revisions of the design. The vendors have access to reporting features which include financial information on the costs and fees that are owed to them or that they owe to other vendors. The ADN System allows vendors to submit e-mails directly to users (photographers) regarding additional costs for artwork, questions on the design or any other communication necessary to complete the project. The ADN System makes for a shorter and more efficient production time than the prior art processes currently available. An entire customized album can be produced in a streamlined rapid order system. The ADN System takes over the extensive production work from photographers necessary in producing customized professional albums.

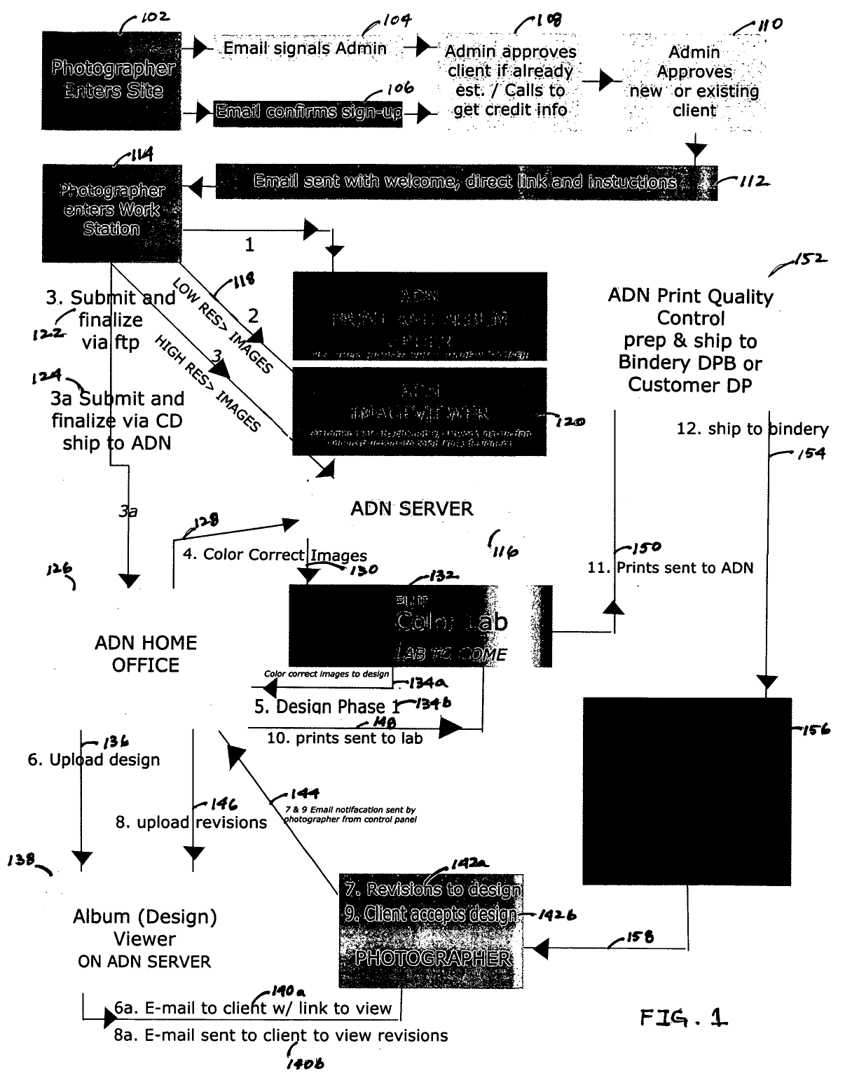

FIG. 1 is a block diagram that illustrates an overview of workflow through the ADN System, according to certain embodiments. FIG. 1 shows that at step 102, a photographer (user) enters an ADN website using a web browser, for example. The ADN website may be the website managed by the ADN network home office or a website managed by a vendor who is participating in the ADN network. Thus, the term “ADN administration” generally refers to the administration of the ADN network home office or that of a participating vendor.

At step 104, if the photographer completes and submits an online registration form, an automated email alert generated by the ADN system signals the ADN administration. For example, the e-mail will provide the photographer's name and pertinent information to the backend reporting system if the photographer is a new member seeking access to the ADN System. Also, as part of the registration procedure, the photographer is asked to confirm his registration. In response, at step 106, an email that confirms registration is sent to the ADN administration.

At step 108, the ADN administration either can make a credit check on the photographer or the administration can proceed to step 110 to approve the photographer's registration if it has been established that the photographer has an acceptable credit history or if the photographer is an established customer of an existing ADN vendor. For example, if the photographer is an existing customer of the vendor and the vendor is in good standing, the vendor can click a button and admit the photographer, thus allowing the photographer entry into the ADN System. If the photographer is a new potential customer, the vendor will contact the photographer to obtain the pertinent information as required by the parameters of the ADN System to give the photographer access to the ADN System.

At step 110, the administration approves the photographer registration. At step 112, the ADN System emails a welcome message including a direct link along with a password and identification number for entering the ADN workstation through the ADN home page. Also included are instructions for using the ADN network.

At step 114, the photographer enters the ADN workstation if he wishes to begin designing and customizing prints and/or one or more photo albums. When the photographer enters the ADN workstation, he can select either a design-and-print option or a design-print-bind option. The design-print-bind option involves the creation of one or more complete photo albums.

At step 118, the photographer is prompted to upload his images to the ADN server 116. At this stage, the photographer need only upload low resolution images to speed up the uploading process. The photographer can view the uploaded images at the ADN imageviewer 120. By using the imageviewer, the photographer can tag one or more of the uploaded images with design instructions. For example, the photographer can specify color correction, cropping of images, and specify artistic design features that he would like added to the one or more of the uploaded images.

Once the photographer has specified the design instructions that he would like the vendors to implement, at step 122, the photographer can finalize and submit his selections for the design of the prints and/or album, at which point, the high resolution version of his images are automatically uploaded to the ADN server. At step 124, the photographer has the option of shipping the high resolution version of his images on a physical storage device, such as a CD-ROM, to the ADN home office 126. For example, the photographer may not have the computer resources or capability of uploading high resolution images to the ADN server. In that case, after the photographer finalizes and submits his selections for the design, the ADN System will automatically electronically package the images along with the photographer's design selections into an electronic folder. The photographer can then copy the electronic folder and its contents into a CD-ROM for mailing to the ADN home office. If the photographer ships the high resolution version of his images to the ADN home office, then at step 128, the ADN home office uploads the high resolution version of the photographer's images to the ADN server 116.

At step 130, the ADN network routes the uploaded high resolution images from the server to a participating color lab 132 selected by the photographer. According to certain embodiments, an electronic notification can be sent to the selected color lab that the images have been uploaded to the ADN server and are in need of color correction. Being a participating vendor in the ADN system, the selected color lab can access the ADN server to access the uploaded images. For example, the color labs computer system performs an automatic sweep of the ADN server and will download all orders that have been submitted to that particular color lab.

Upon completion of the color correction, at step 134a, the color corrected images are sent electronically, according to certain embodiments to the participating graphic designers. At step 134b, the graphic designers create artistically designed pages of the album and upload these pages to the ADN System. At step 136, the ADN System displays the uploaded pages as a virtual album on a customized webpage for the photographer, so that the photographer can show the virtual album to the photographer's clients. Upon completion of the design, the graphics designers either directly upload the virtual album to the ADN server or send the virtual album to the ADN home office.

At step 140a, an automated email notification is sent to the photographer with a link to view the online virtual album. The photographer can view the virtual album using the online album viewer and can make notes for revisions for each page of the virtual album. At step 142, the photographer can either approve the virtual album (step 142a) or the photographer can suggest revisions (142b) for one or more pages of the virtual album if revisions are desired.

At step 144, the photographer either sends his approval or he sends his suggested revisions of the album design to the ADN home office. If the photographer sends his suggested revisions of the album design, then step 134b is repeated where graphics designers make revisions to the album design based on the photographer's instructions. After the graphics designers complete the revisions of the album design, then at step 146, the revised album design is once again uploaded to the album design viewer 138. At step 140b, an automated email notification is sent to the photographer to view the revisions of the album design. Steps 142, 144, 134b, 146, and 140b are repeated until the photographer approves of the design of the album.

After the photographer approves of the design of the album, at step 148, the ADN home office sends the designed album pages in the form of electronic files to the selected color lab 132 for printing. At step 150, the color lab sends the printed album pages with images back to the ADN home office. At step 152, the ADN home office inspects the printed images from the color lab to ensure good quality.

At step 154, the ADN home office either send the prints to the photographer if the photographer has previously selected the design-and-print option or the ADN home office can send the printed album pages with the images to a participating bindery selected by the photographer if the photographer has previously selected the design-print-bind option.

At step 156, the selected bindery manufactures the album according to the album design features selected by the user. For example, the bindery manufactures the album based on the album material, album color, album color edging, seam color, inscription, etc., as selected by the photographer in the initial ordering phase. At step, 158, the finished album is dropped shipped to the photographer.

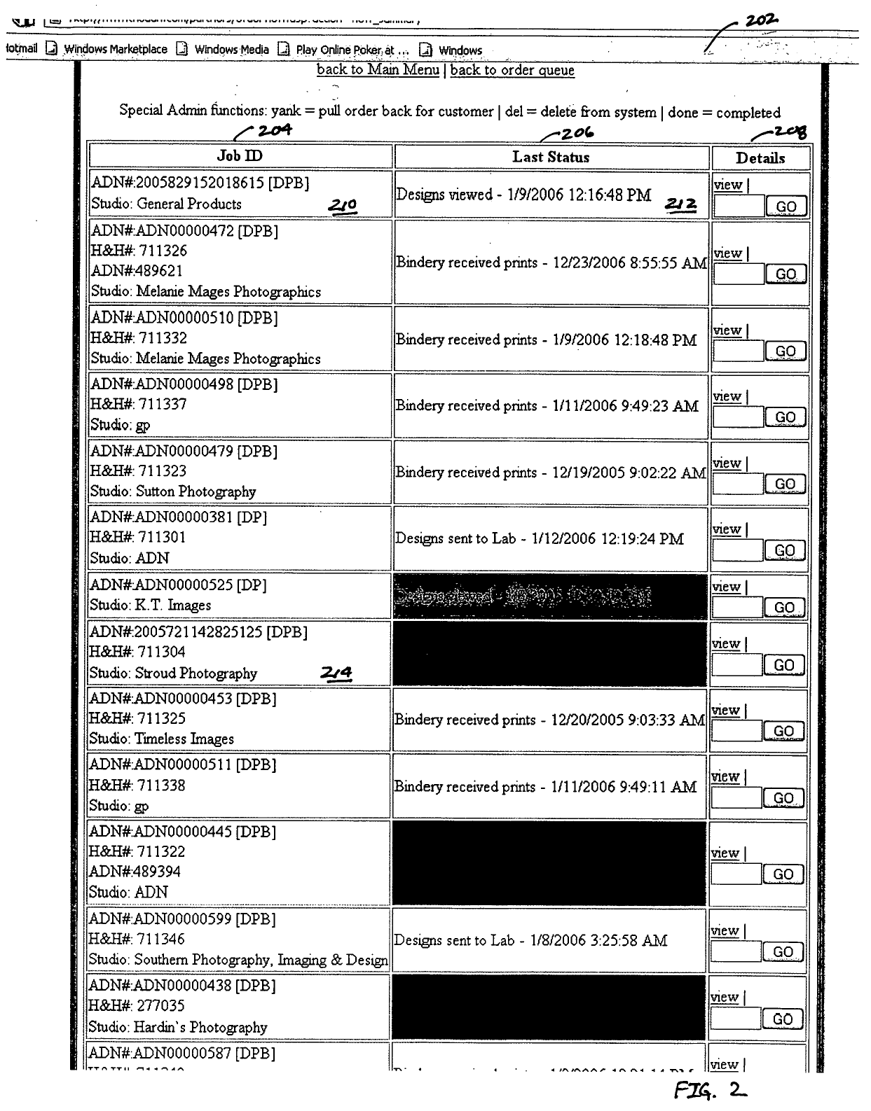

FIG. 2 is snapshot of an online control panel that can be accessed by members of the ADN System for tracking each phase in the making of a given album, according to certain embodiments.

FIG. 2 shows a page 202 of an online control panel in the ADN system. Such a control panel allows a member of the ADN system to track, in real-time, the progress and location of an album or print order in the production process. Page 202 shows a job ID 204, a status column 206 and a details column 208. For example, job ID column 204 shows a job order 210 for a customer, General Products studio. The corresponding status for job order 210 is status 212. Status 212 shows that the designs of the images and or album are viewed on the date and time indicated by status 212. As another example, page 202 shows a job ID 214 for a customer, Stroud Photography studio. The corresponding status for job order 214 is status 216. Status 216 shows that the selected bindery shipped the finished album to the customer on the date and time indicated by status 216.

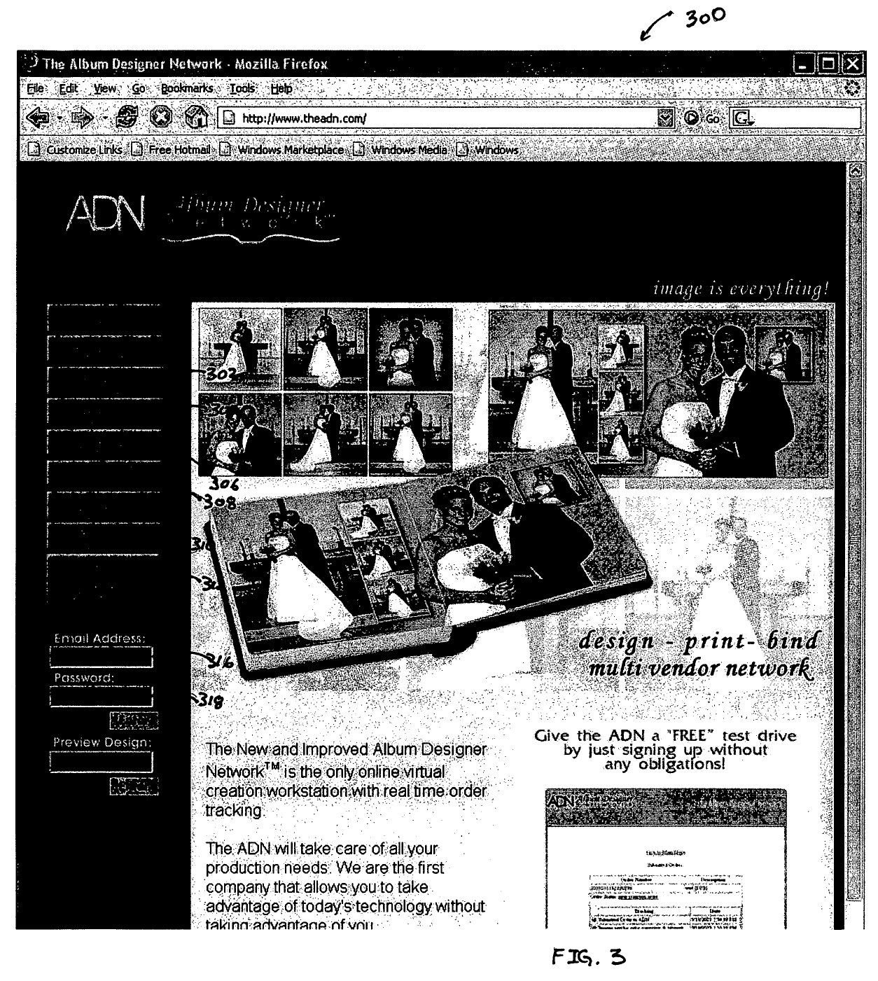

FIGS. 3 through 17 are snapshots of web pages showing non-limiting examples of a no-fault workflow of the ADN workstation application. The features shown FIGS. 3 through 17 are optional and may vary from implementation to implementation depending on the services offered by the participating vendors. FIG. 3 shows a sample home page of the ADN System website, according to certain embodiments. FIG. 3 shows, among several features, selection buttons that a user can select to learn of the different services and features provided by the ADN System. For example, home page 300 can include selection buttons for description on services such as Design 302, Print 304, Bind 306, and Portfolio 308. Home page 300 includes a sign-up selection button 310 and a selection button 312 for description on the ADN Workstation. If the photographer (user) is already a member of the ADN System, the user can sign-in by providing his email address in box 316 and password in box 318.

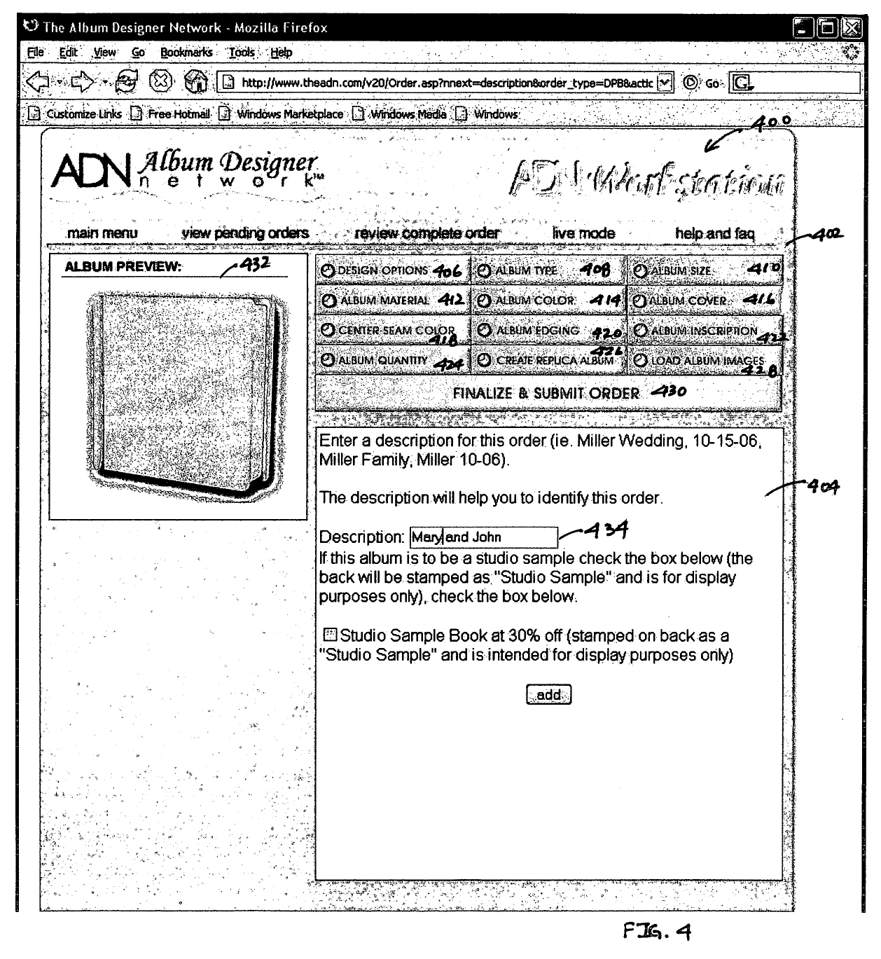

FIG. 4 is shows a web page 400 that a photographer sees when the photographer enters the ADN Workstation application, according to certain embodiments. Web page 400 shows a features panel 402 of selectable buttons that guide a user through a no-fault selection process whereby the photographer can select various design features for his prints and/or album. Panel 402 shows some non-limiting examples of features that a user can select, such as Design Options 406, Album Type 408, Album Size 410, Album Material 412, Album Color 414, Album Cover 416, Center Seam Color 418, Album Edging 420, Album Inscription 422, Album Quantity 424, Create Replica Album 426, Load Album Images 428 and Finalize & Submit Order 430. The above features are merely examples, and thus the number and type of selectable design features for prints and albums may vary from implementation to implementation. Web page 400 also shows a dialog box 404 where the photographer can type in a descriptive name for identifying his order in box 434. Further, web page 400 shows an Album Preview panel 432. The Album Preview panel 432 shows the photographer's itemized selections with cost breakdown as the photographer makes his design selections by navigating the no-fault selection process.

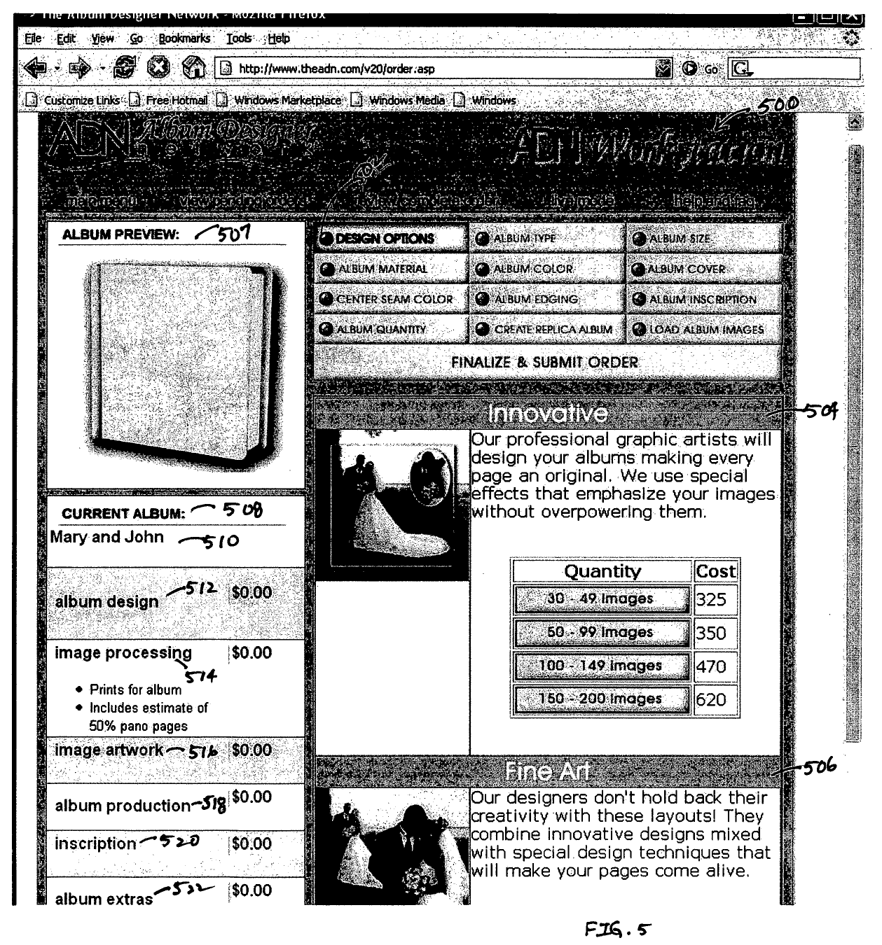

FIG. 5 shows the Design Options page 500 of the ADN workstation application, according to certain embodiments. FIG. 5 shows that Design Options button 502 is highlighted to indicate that the photographer has entered the Design Options page. Design Options page 500 includes a description and cost information corresponding to each graphics design type such as the “innovative” type 504 and “fine art” type 506. Only one graphics design vendor and only two graphics design types are shown. However, the ADN System is not limited to a specific number of vendors or to specific types of design. FIG. 5 also shows the Album Preview panel 507. As a non-limiting example, the Album Preview panel 507 can show the Current Album 508, an identifying name of the current album 510, an album design,and cost summary 512, an image processing and cost summary 514, an image artwork and cost summary 516, an album production and cost summary 518, an inscription and cost summary 520, album extras and cost summary 522, etc. The Album Preview panel 507 can vary from implementation to implementation.

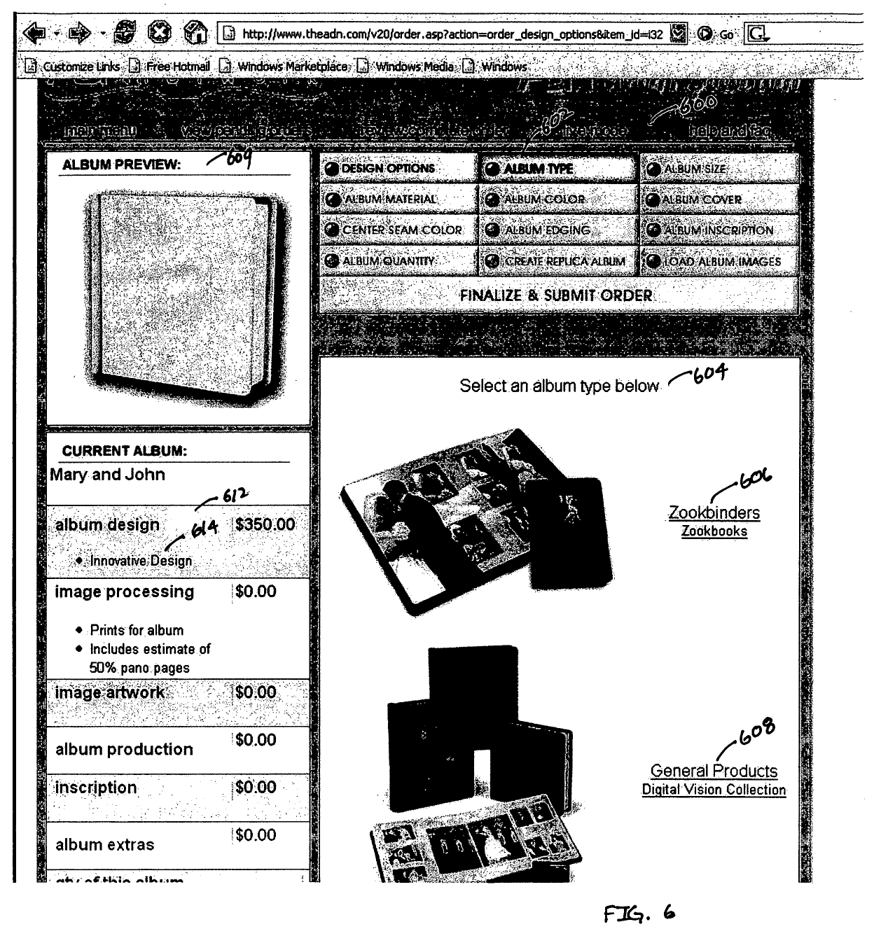

FIG. 6 shows the Album Type page 600 of the ADN workstation application, according to certain embodiments. FIG. 6 shows that Album Type button 602 is highlighted to indicate that the photographer has entered the Album Type page. Album Type page 600 includes an album type panel 604 where the photographer can select from album types such as types 606 and 608 provided by various album vendors. The ADN System is not limited to a specific number of types of albums or to specific album manufacturers. The available album types may vary from implementation to implementation. FIG. 6 also shows the Album Preview panel 609. Album Preview panel 609 shows that the photographer has previously selected Innovative Design 614 as the graphic design style as shown in the album design and cost summary 612.

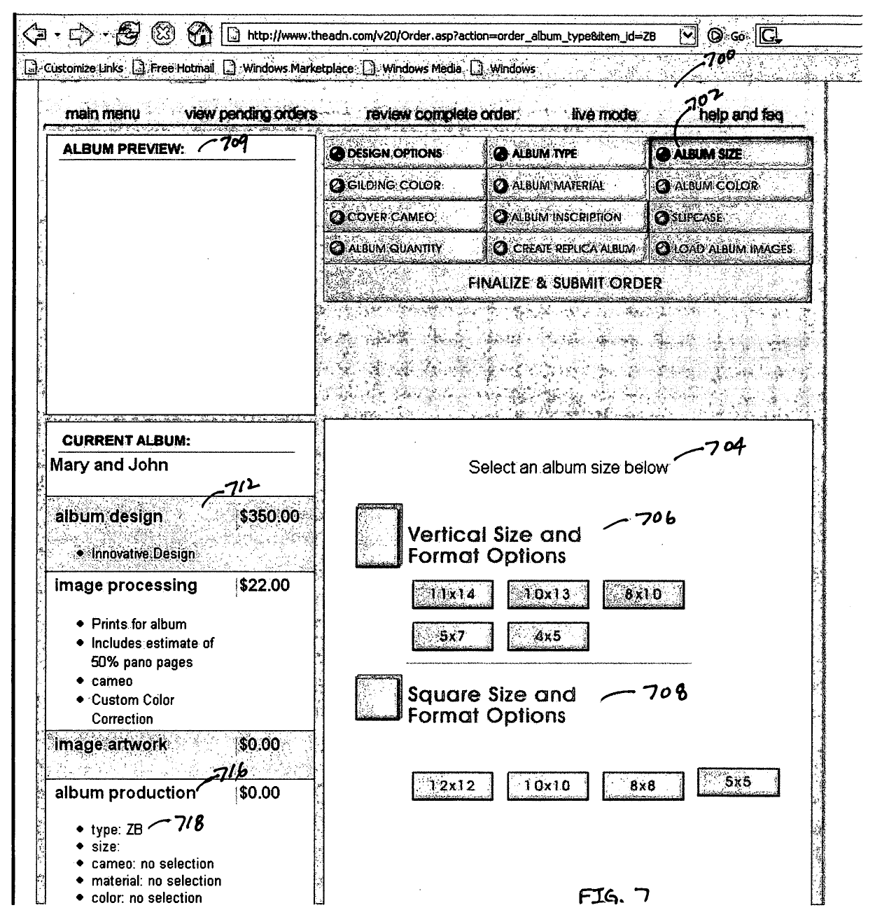

FIG. 7 shows the Album Size page 700 of the ADN workstation application, according to certain embodiments. FIG. 7 shows that Album Size button 702 is highlighted to indicate that the photographer has entered the Album Size page. Album Size page 700 includes an album size selection panel 704. Album size selection panel 704 shows some non-limiting examples of album size choices 706 and 708. The available album sizes may vary from implementation to implementation. FIG. 7 also shows the Album Preview panel 709. Album Preview panel 709 shows that the photographer has previously made a selection of a design style and image quantity as shown in the album design and cost summary 712. Album Preview panel 709 also shows that the photographer has previously selected album type 718 as shown in the album production and cost summary 716.

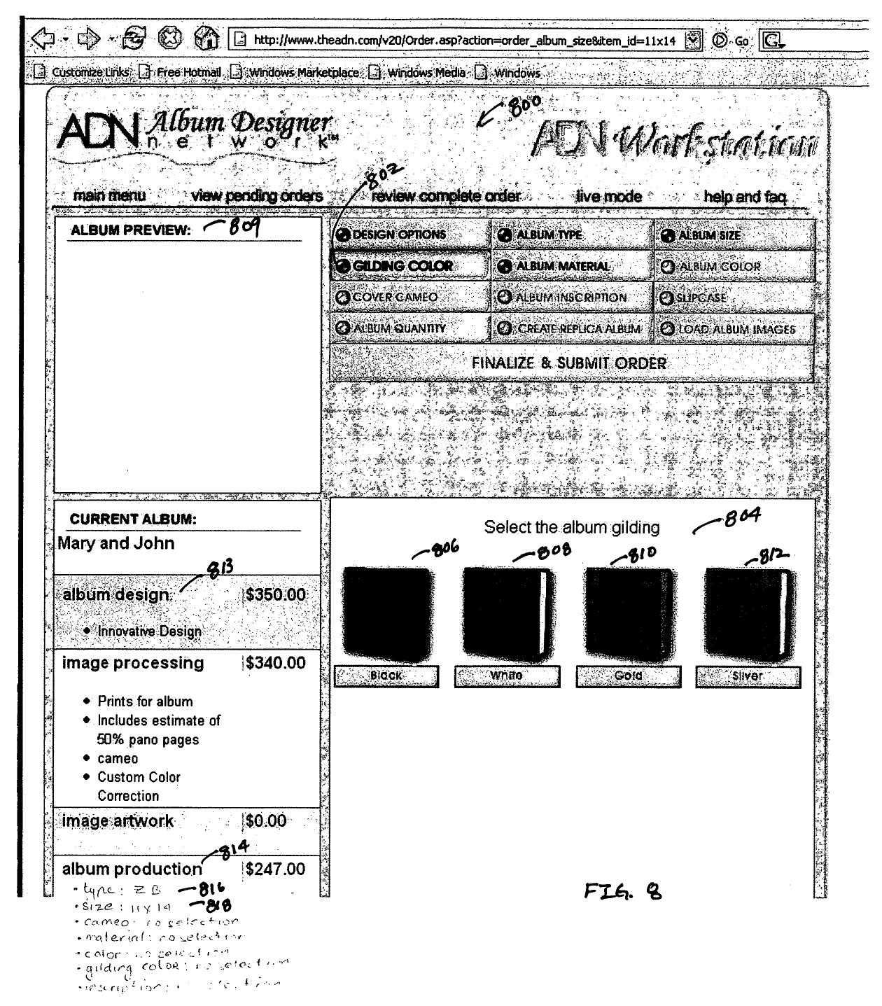

FIG. 8 shows the Gilding Color page 800 of the ADN workstation application, according to certain embodiments. FIG. 8 shows that Gilding Color button 802 is highlighted to indicate that the photographer has entered the Gilding Color page. Gilding Color page 800 includes an album gilding selection panel 804. Gilding Color selection panel 804 shows some non-limiting examples of gilding color choices such as black 806, white 808, gold 810, and silver 812. The available gilding colors may vary from implementation to implementation. FIG. 8 also shows the Album Preview panel 809. Album Preview panel 809 shows that the photographer has previously made a selection of a design style and image quantity as shown in the album design and cost summary 813. Album Preview panel 809 also shows that the photographer has previously selected album type 816 and album size 818 as shown in the album production and cost summary 814.

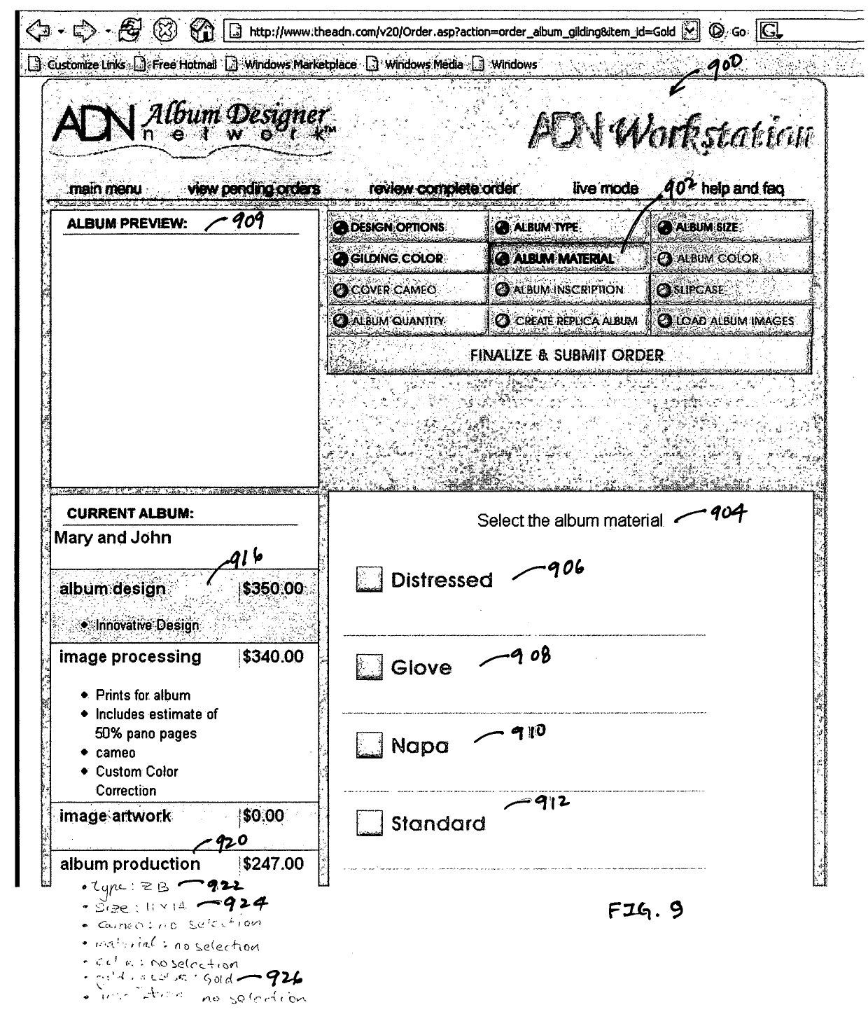

FIG. 9 shows the Album Material page 900 of the ADN workstation application, according to certain embodiments. FIG. 9 shows that Album Material button 902 is highlighted to indicate that the photographer has entered the Album Material page. Album Material page 900 includes an album material selection panel 904. Album material selection panel 904 shows some non-limiting examples of album material choices such as Distressed 906, Glove 908, Napa 910, and Standard 912. The available album material may vary from implementation to implementation. FIG. 9 also shows the Album Preview panel 909. Album Preview panel 909 shows that the photographer has previously made a selection of a design style and image quantity as shown in the album design and cost summary 916. Album Preview panel 909 also shows that the photographer has previously selected album type 922, album size 924, and gilding color 926 as shown in the album production and cost summary 920.

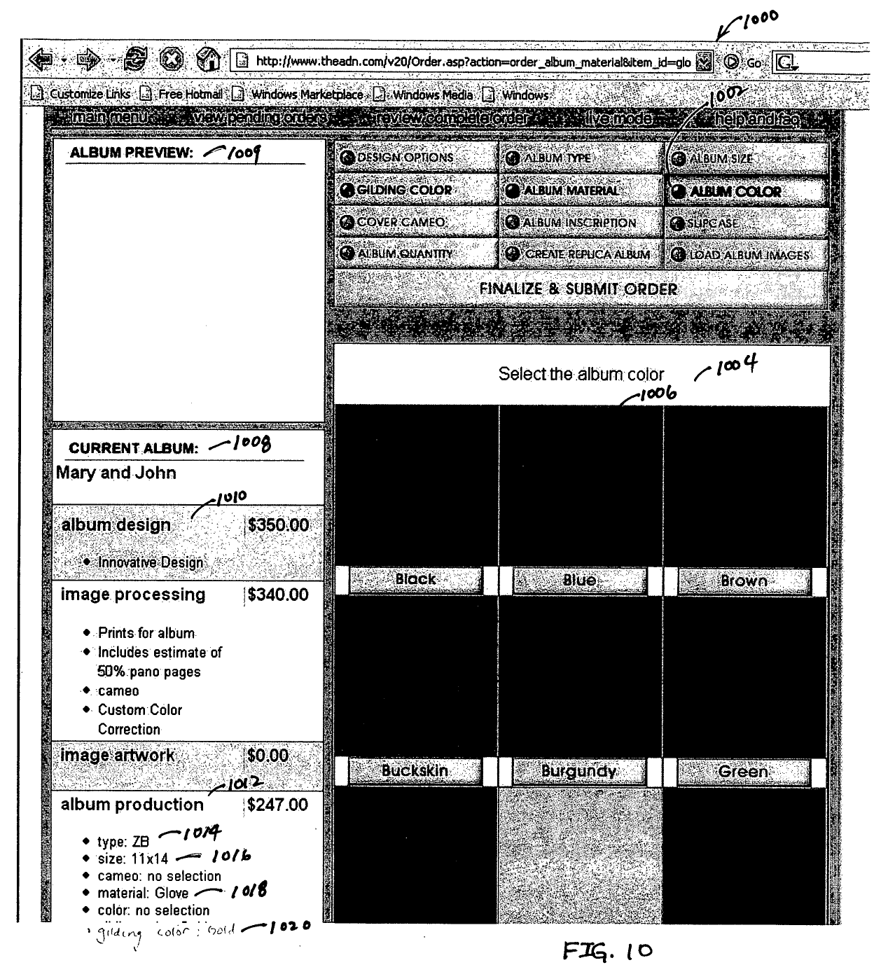

FIG. 10 shows the Album Color page 1000 of the ADN workstation application, according to certain embodiments. FIG. 10 shows that Album Color button 1002 is highlighted to indicate that the photographer has entered the Album Color page. Album Color page 1000 includes an album color selection panel 1004. Album Color selection panel 1004 shows some non-limiting examples of album color choices 1006. The available album color may vary from implementation to implementation. FIG. 10 also shows the Album Preview panel 1009. Album Preview panel 1009 shows that the photographer has previously made a selection of a design style and image quantity as shown in the album design and cost summary 1010. Album Preview panel 1009 also shows that the photographer has previously selected album type 1014, album size 1016, album material 1018 and gilding color 1020 as shown in the album production and cost summary 1012.

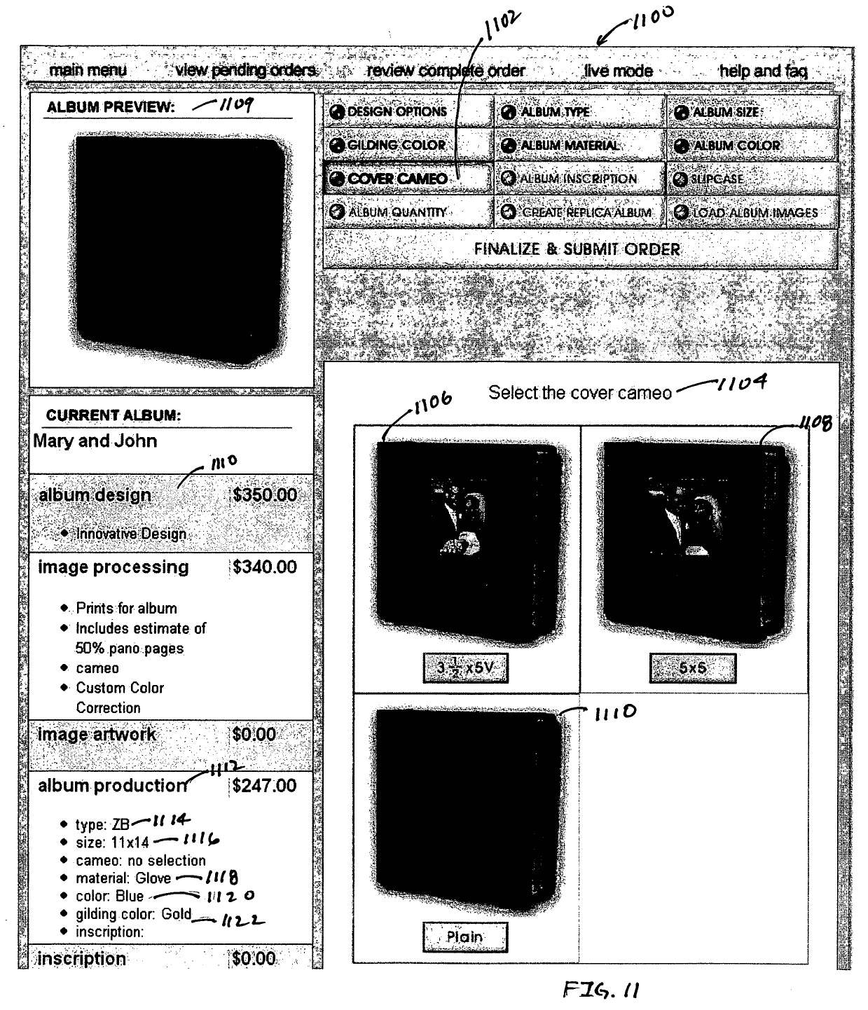

FIG. 11 shows the Cover Cameo page 1100 of the ADN workstation application, according to certain embodiments. FIG. 11 shows that Cover Cameo button 1102 is highlighted to indicate that the photographer has entered the Cover Cameo page. Cover Cameo page 1100 includes a cover cameo selection panel 1104. Cover Cameo selection panel 1104 shows some non-limiting examples of cover cameo choices, such as 3½×5V, 5×5 1108, and Plain 1110. The available cover cameos may vary from implementation to implementation. FIG. 11 also shows the Album Preview panel 1109. Album Preview panel 1109 shows that the photographer has previously made a selection of a design style and image quantity as shown in the album design and cost summary 1110. Album Preview panel 1109 also shows that the photographer has previously selected album type 1114, album size 1116, album material 1118, album color 1120 and gilding color 1122 as shown in the album production and cost summary 1112.

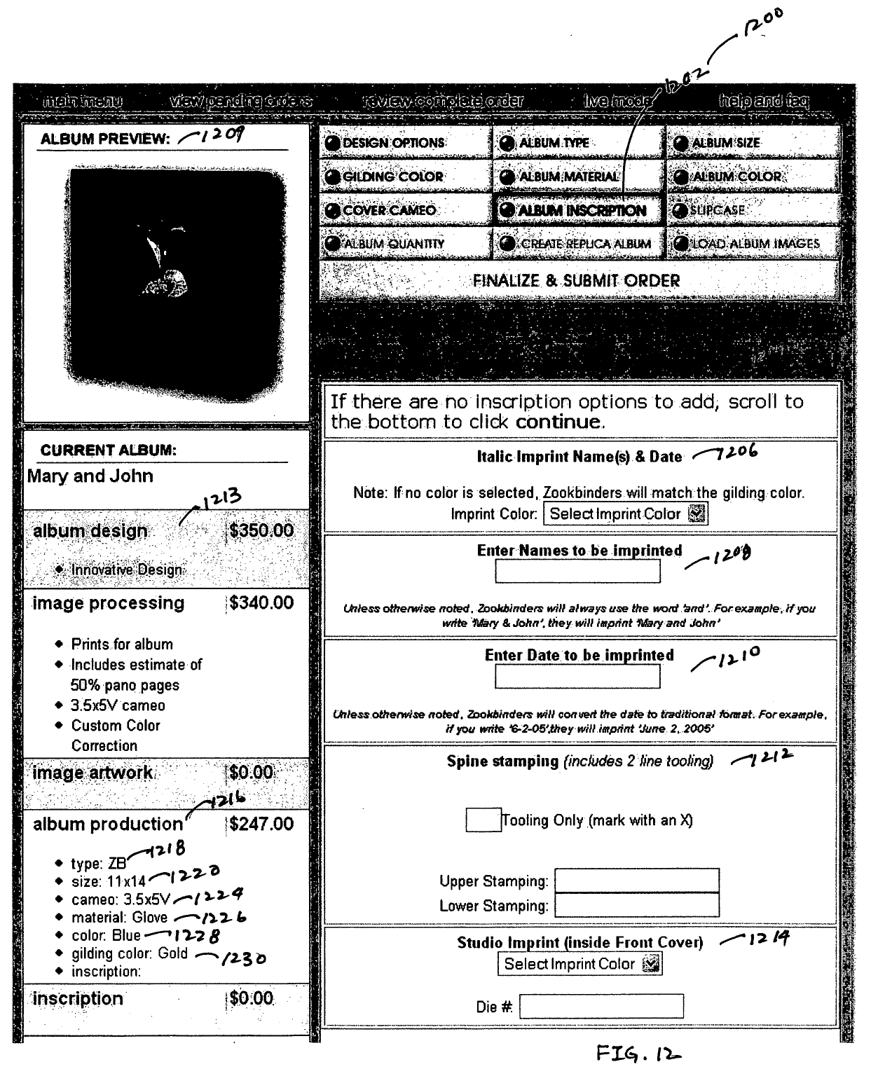

FIG. 12 shows the Album Inscription page 1200 of the ADN workstation application, according to certain embodiments. FIG. 12 shows that Album Inscription button 1202 is highlighted to indicate that the photographer has entered the Album Inscription page. Album Inscription page 1200 includes an album inscription selection panel 1204. Album Inscription selection panel 1204 shows some non-limiting examples of Album Inscription options, such as Italic Imprint Names & Date 1206, Names To Be Imprinted 1208, Date To Be Imprinted 1210, Spine Stamping 1212 and Studio Imprint 1214. The available inscription options may vary from implementation to implementation. FIG. 12 also shows the Album Preview panel 1209. Album Preview panel 1209 shows that the photographer has previously made a selection of a design style and image quantity as shown in the album design and cost summary 1213. Album Preview panel 1209 also shows that the photographer has previously selected album type 1218, album size 1220, cover cameo 1224, album material 1226, album color 1228 and gilding color 1230 as shown in the album production and cost summary 1216.

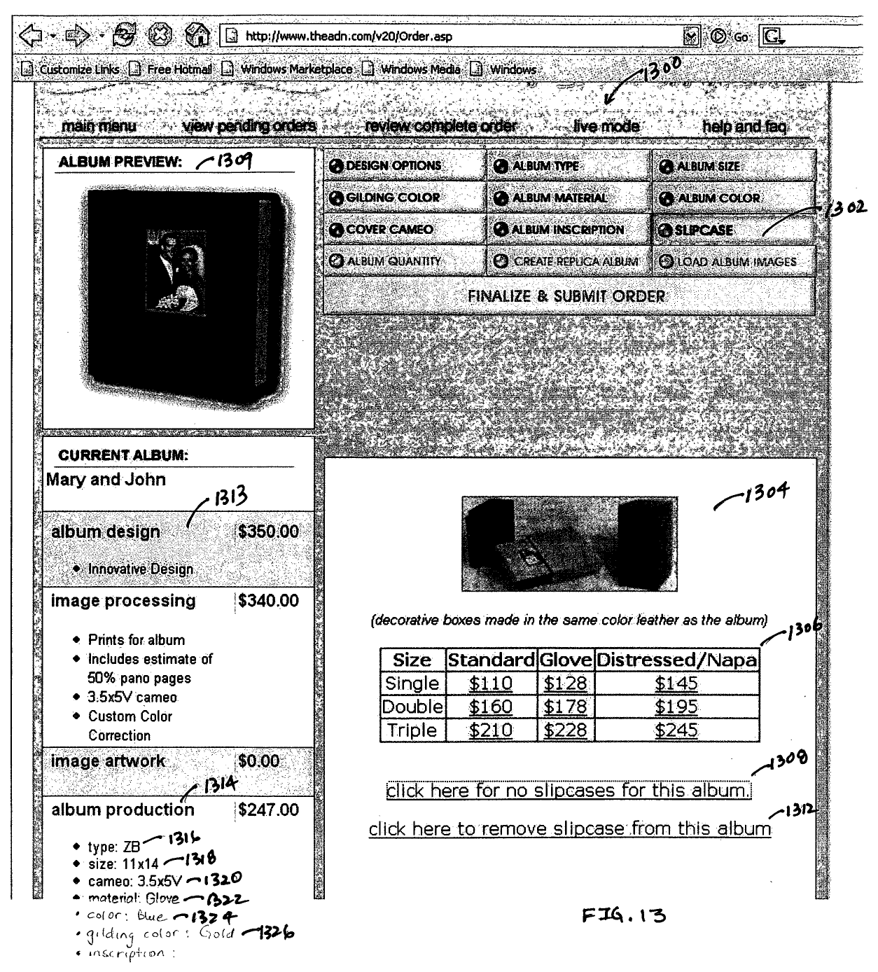

FIG. 13 shows the Slipcase page 1300 of the ADN workstation application, according to certain embodiments. FIG. 13 shows that Slipcase, button 1302 is highlighted to indicate that the photographer has entered the Slipcase page. Slipcase page 1300 includes a slipcase selection panel 1304. Slipcase selection panel 1304 shows some non-limiting examples of slipcase options 1306. The photographer may decline to have a slipcase by choosing option 1308. The photographer may also remove his selected slipcase by choosing option 1312. The available slipcase options may vary from implementation to implementation. FIG. 13 also shows the Album Preview panel 1309. Album Preview panel 1309 shows that the photographer has previously made a selection of a design style and image quantity as shown in the album design and cost summary 1313. Album Preview panel 1309 also shows that the photographer has previously selected album type 1316, album size 1318, cover cameo 1320, album material 1322, album color 1324 and gilding color 1326 as shown in the album production and cost summary 1314.

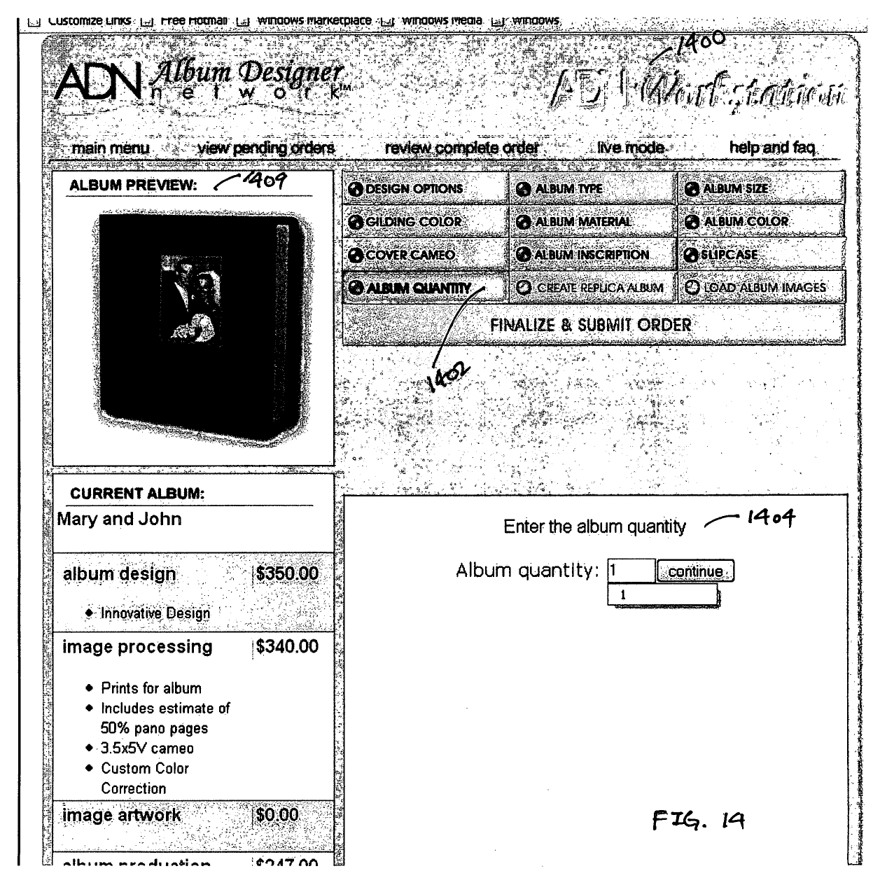

FIG. 14 shows the Album Quantity page 1400 of the ADN workstation application, according to certain embodiments. FIG. 14 shows that Album Quantity button 1402 is highlighted to indicate that the photographer has entered the Album Quantity page. Album Quantity page 1400 includes an album quantity selection panel 1404 where the photographer can type in the number of albums desired. FIG. 14 also shows the Album Preview panel 1409. Album Preview panel 1409 is similar to the Album Preview panels as previously described herein.

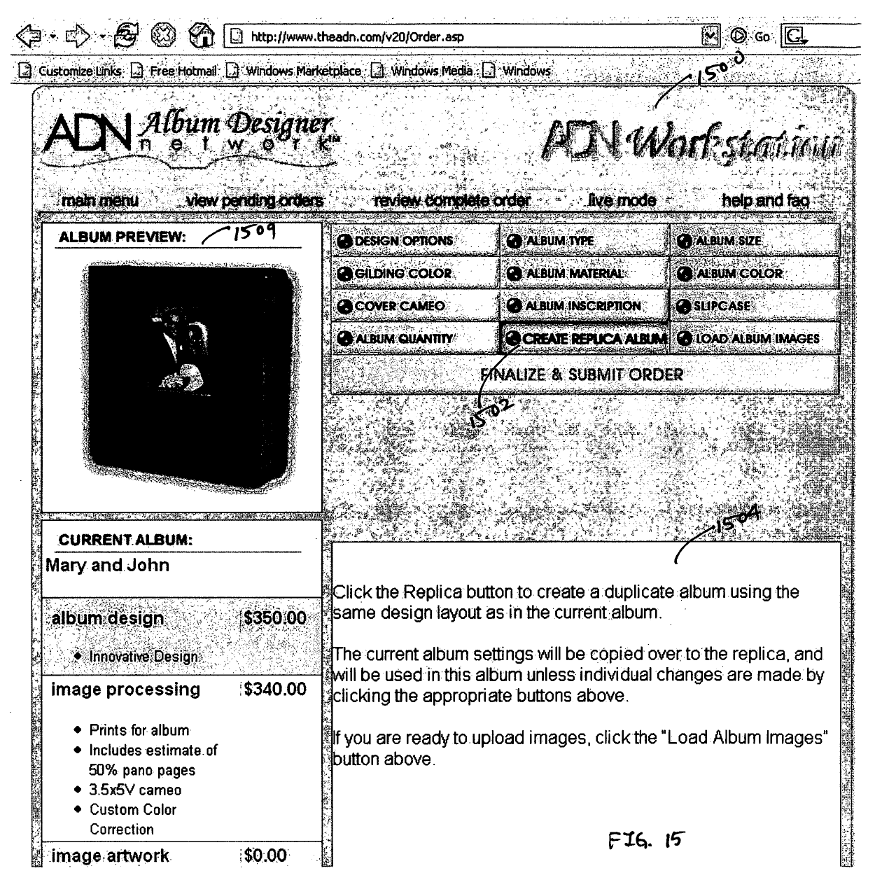

FIG. 15 shows the Create Replica Album page 1500 of the ADN workstation application, according to certain embodiments. FIG. 15 shows that Create Replica Album button 1502 is highlighted to indicate that the photographer has entered the Create Replica Album page. Create Replica Album page 1500 includes a Create Replica Album description and instruction panel 1504. As a non-limiting example, Create Replica Album description and instruction panel 1504 includes the instruction that the current album settings will be copied over to the replica album and will be used in the replica album unless individual changes are made by selecting the appropriate buttons such as Design Options, Album Type, Album Size, Album Material, Album Color, Album Cover, Center Seam Color, Album Edging, Album Inscription, etc. FIG. 15 also shows the Album Preview panel 1509. Album Preview panel 1509 is similar to the Album Preview panels as previously described herein.

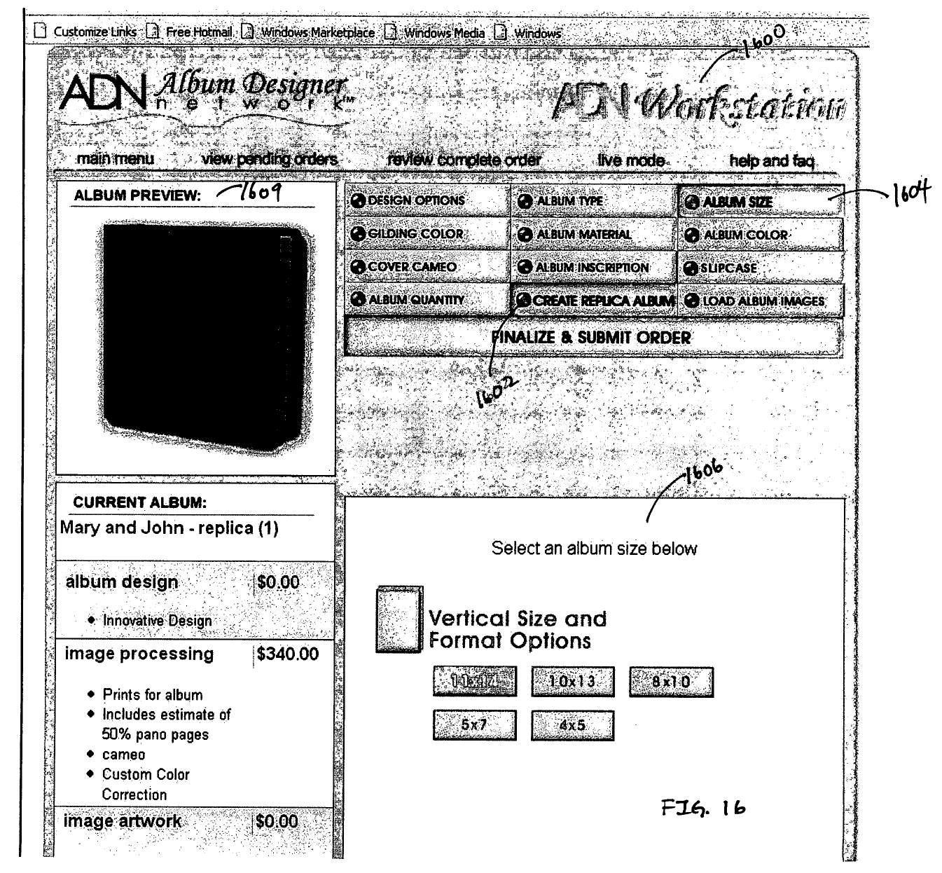

Assume that the photographer wishes to create a replica album but wishes to change some of album features in the replica album. For example, assume that the photographer wishes to change the album size and the album cover in the replica album. FIG. 16 shows the Album Size page 1600 of the ADN workstation application for the replica album, according to certain embodiments. FIG. 16 shows that the Create Replica Album button 1602 and Album Size button 1604 are highlighted to indicate that the photographer has entered the Album Size page for his replica album. FIG. 16 also shows the Album Preview panel 1609 for the replica album. Album Preview panel 1609 is similar to the Album Preview panels as previously described herein.

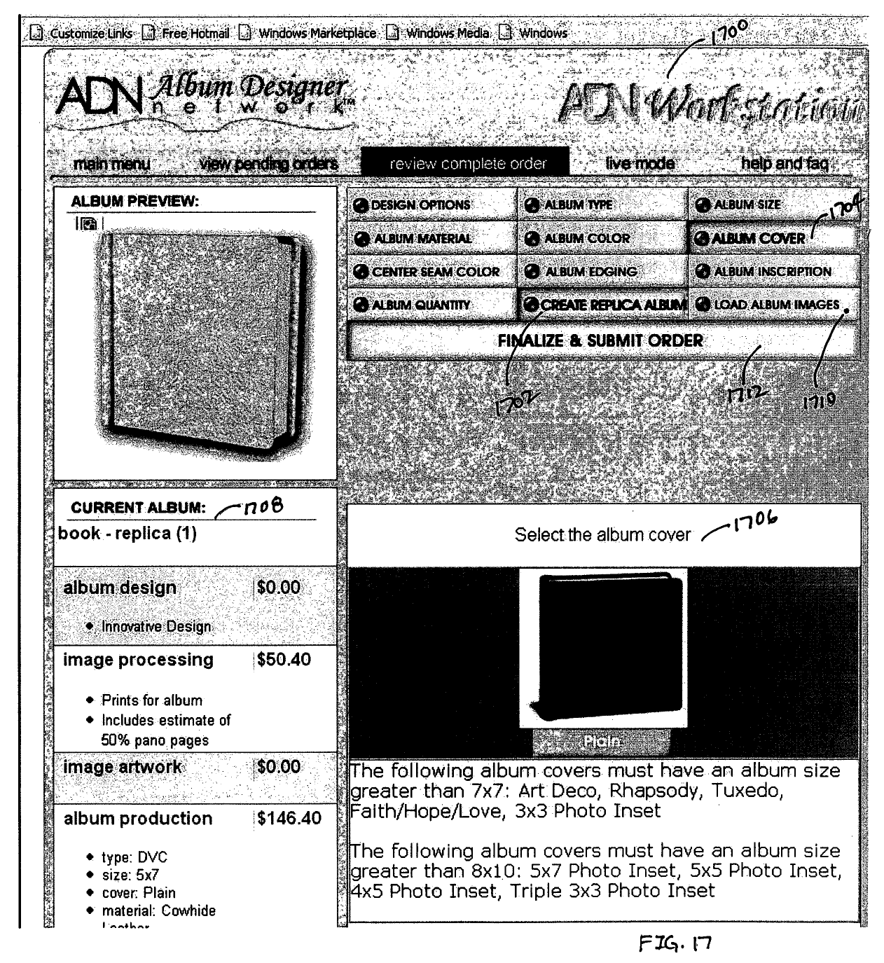

FIG. 17 shows the Album Cover page 1700 of the ADN workstation application for the replica album, according to certain embodiments. FIG. 17 shows that the Create Replica Album button 1702 and Album Cover button 1704 are highlighted to indicate that the photographer has entered the Album Cover page for his replica album. FIG. 17 also shows the Album Preview panel 1709 for the replica album. Album Preview panel 1709 is similar to the Album Preview panels as previously described herein. After the photographer has made his design selections, he can select the Load Album Images button 1710 in order to upload his images to the ADN server. Finally, the photographer can select to Finalize and Submit Order button 1712.

In the foregoing specification, embodiments of the invention have been described with reference to numerous specific details that may vary from implementation to implementation. The specification and drawings are, accordingly, to be regarded in an illustrative rather than a restrictive sense.

We claim:

1. A method in a computing system for photo album creation, the method comprising:
providing a turnkey online system for at least one of digitally designing, printing, binding and ordering photo albums, wherein said turnkey online system includes providing a web-based online workstation that guides a user through an automated workflow with a graphical interface for said designing and ordering by allowing said user to select between competing design, print and bindery vendors within each order of one or more photo albums, and automatically coordinating with vendors selected by said user in a manner that is transparent to said user to provide a finished product to said user.

2. The method of claim 1, wherein said turnkey online system is accessible by said user through a web browser from any location and using any operating system.

3. The method of claim 1, further comprising providing a selection procedure to said user to create a no-fault system for said vendors by requiring said user to be responsible for making, reviewing, and authorizing selection options before said vendors design or manufacture said photo albums for said user.

4. The method of claim 1, further comprising an electronic notification procedure for notifying said user of one or more stages of a design phase and production of said photo albums.

5. The method of claim 1, further comprising providing a real-time electronic tracking mechanism to said user after said user has submitted an order for one or more of prints and said one or more photo albums wherein said mechanism allows said user to track each stage of production of said prints and said one or more photo albums.

6. The method of claim 1, further comprising providing an automated accounting system including a reporting feature to said vendors.

7. The method of claim 1, further comprising:
providing visual feedback to said user as said user navigates through said automated workflow, wherein said visual feedback includes a display of images and text based on selections made by said user at each stage of said workflow.

8. The method of claim 1, further comprising providing an integration mechanism for integrating said turnkey online system with corresponding legacy accounting, reporting and production systems associated with each vendor.

9. The method of claim 1, further comprising providing an automated electronic monitoring mechanism for monitoring progress of a production flow associated with each submitted order for photo albums.

10. The method of claim 9, further comprising flagging orders that have a delay in said progress of said production flow.

11. The method of claim 10, further comprising providing an automated electronic alert mechanism for notification of said delay.

12. The method of claim 1, further comprising posting an online version of said finished product for review and final approval by said user.

13. The method of claim 1, further comprising providing an archiving mechanism for allowing said user to archive any number of online version of finished products.

14. The method of claim 1, further comprising providing an online light-board for allowing said user to layout photographs in a desired sequence of display and to attach any design and printing instructions for each photograph in said sequence.

15. The method of claim 1, further comprising providing an online slide show version of said finished product set to music for a web presentation to customers of said user.

16. The method of claim 6, wherein said accounting system includes tracking payments owed and paid to each vendor.

17. A method for photo album creation, the method comprising:
providing an automated print and album order web-based interface for selecting, by a user, photograph print design options and album design options;
allowing said user to upload images to an online image-viewer for viewing and for specifying design details associated with said images;
automatically sending said images to a user-selected print laboratory for color-correction according to said specified design details;
automatically sending said color-corrected images to graphic designers for designing said images according to said specified design details for creating a virtual album;
allowing said user to review said virtual album and specify design revisions through said web-based interface;
automatically sending final user approved images to said print laboratory for making prints of said final user approved images;
performing quality control checks on said prints; and
automatically performing any one of sending said prints to said user and sending said prints to a user-selected bindery for manufacturing said photo album.

18. An automated system for an album creation, the system comprising:
a selection means for selecting, by a user, photograph print design options and album design options;
a viewing means for viewing and for specifying design details associated with images; and
a user design control means for allowing user to track and control a design phase of prints of said images and said album.

19. A computer-readable medium carrying one or more sequences of instructions for photo album creation, wherein execution of the one or more sequences of instructions by one or more processors causes the one or more processors to perform:
providing a turnkey online system for designing, and ordering photo albums, wherein said turnkey online system includes providing a web-based online workstation that guides a user through an automated workflow with a graphical interface for said designing and ordering by allowing said user to select between competing design, print and bindery vendors within each order of multiple photo albums, and automatically coordinating with vendors selected by said user in a manner that is transparent to said user to provide a finished product to said user.
